(19) United States
(12) Patent Application Publication
(10) Pub. No.: US 2026/0015172 A1
(43) Pub. Date: Jan. 15, 2026

(54) HIGH-DENSITY INTELLIGENT STORAGE SYSTEM AND STORAGE METHOD

(71) Applicant: Hong Kong Centre for Logistics Robotics Limited, Hong Kong (CN)

(72) Inventors: Yunhui LIU, Hong Kong (CN); Huanfeng HUANG, Hong Kong (CN); Bingnan LIANG, Hong Kong (CN)

(21) Appl. No.: 18/909,974

(22) Filed: Oct. 9, 2024

(30) Foreign Application Priority Data
Jul. 9, 2024 (CN) 2024109156095

(51) Int. Cl. B65G 1/137; B65G 1/04

(52) U.S. Cl. CPC B65G 1/1371; B65G 1/0435; B65G 1/1376

(57) ABSTRACT

The present invention discloses a high-density intelligent storage system and a storage method. The storage system includes rack assemblies and a storage and retrieval robot. A plurality of rack assemblies are provided, and the plurality of rack assemblies are arranged in parallel. The storage and retrieval robot is configured to transfer totes. An aisle is provided on at least one side of each rack assembly for allowing for movement of the storage and retrieval robot. Each rack assembly includes a pair of racks arranged side-by-side and a tote transport mechanism. The tote transport mechanism is in communication with the pair of racks to deliver totes between the two racks. The storage and retrieval robot is drivingly connected to the tote transport mechanism, and the storage and retrieval robot and the tote transport mechanism can deliver the tote to each other. With such an arrangement, the racks cooperate with the tote transport mechanism so that the layout design of the rack assemblies is rational and orderly, and the side-by-side placement of the racks can reduce the number of unnecessary aisles in a warehouse. Through the rational and orderly multi-tote parallel storage of the tote transport mechanism on the racks, the distance between adjacent totes is reduced, and the space utilisation rate of the warehouse is significantly increased.

### TECHNICAL FIELD

The present invention relates to the technical field of three-dimensional warehouses, and more particularly to a high-density intelligent storage system and a storage method.

### BACKGROUND OF INVENTION

Intelligent warehousing is a link in a logistics process, and the application of the intelligent warehousing ensures the speed and accuracy of data input in all links of goods warehouse management, and ensures that an enterprise accurately masters the real data of the inventory in a timely manner and reasonably holds and controls the inventory of the enterprise. Through an intelligent algorithm, it is also possible to conveniently and scientifically manage the batches and inventory quantities of inventory goods.

The existing warehousing system contains multiple rows of racks arranged in a warehouse. Goods are placed on the racks, and aisles are provided between the racks for warehousing robots to pass through and transport goods. However, this system has the drawback of low-density storage.

### SUMMARY OF INVENTION

The objective of the invention is to provide a high-density intelligent storage system in order to solve at least one of the aforementioned technical problems.

In order to achieve the aforementioned objective of the invention, the technical solutions adopted by the present invention are as follows.

In the first aspect, the present invention provides a high-density intelligent storage system, including:
rack assemblies, a plurality of rack assemblies being provided, and the plurality of rack assemblies being arranged in parallel; and
a storage and retrieval robot configured to transfer totes, wherein
at least one side of the rack assembly is provided with an aisle to allow for the movement of the storage and retrieval robot;
each rack assembly includes a pair of racks arranged side-by-side and a tote transport mechanism, the tote transport mechanism being in communication with the pair of racks arranged side-by-side for delivering totes between the two racks; and
the storage and retrieval robot is drivingly connected to the tote transport mechanism, and these two parts are capable of delivering totes to each other.

With such an arrangement, the racks cooperate with the tote transport mechanism so that the layout design of the rack assemblies is rational and orderly, and the side-by-side placement of the racks can reduce the number of unnecessary aisles in a warehouse. The tote transport mechanism allows for rational and orderly multi-tote parallel storage on the racks, reducing the distance between adjacent totes and significantly increasing the warehouse's space utilisation rate.

Preferably, the storage and retrieval robot includes a docking mechanism, the tote transport mechanism includes a docking assembly, and the docking assembly and the docking mechanism are drivingly connected.

Preferably, the tote transport mechanism includes a body, which includes a gear assembly and a transport chain, wherein the gear assembly is drivingly connected to the docking assembly in a gear meshing manner; and the gear assembly is further drivingly connected to the transport chain, and the transport chain is configured to carry and convey the tote.

Preferably, the tote transport mechanism includes a body, which includes a roller assembly and a conveyor belt, wherein the conveyor belt is sleeved on the roller assembly for carrying and conveying the tote, and the docking assembly is drivingly connected to the roller assembly in a meshing manner.

Preferably, the storage and retrieval robot further includes a rotary transport mechanism and an upright column, wherein the rotary transport mechanism is located either upstream or downstream of the tote transport mechanism when the docking assembly and the docking mechanism are inserted into each other, and the docking mechanism is integrated into the rotary transport mechanism;
the upright column is arranged in a vertical direction; and
the upright column is provided with a lifting mechanism, and the rotary transport mechanism is slidably connected to the lifting mechanism so as to move in the vertical direction relative to the upright column.

With such an arrangement, according to the different heights of totes on the racks, the rotary transport mechanism can be moved to a corresponding specified height by the lifting mechanism, such that the docking assembly and the docking mechanism can be accurately docked with each other.

Preferably, the storage and retrieval robot further includes a storage mechanism, and the storage mechanism and the rotary transport mechanism are respectively arranged on two sides of the upright column; and the storage mechanism includes a plurality of storage places in a uniform array in an extension direction of the upright column.

Preferably, the body further includes a load-bearing slide rail, the load-bearing slide rail extending in a transport direction of the transport chain, and the load-bearing slide rail and the transport chain both abutting against a bottom plate of the tote.

More preferably, a central control module is further included, wherein the central control module is configured to send instructions to the storage and retrieval robot;
the storage and retrieval robot includes a mobile chassis, within which a walking mechanism configured to provide walking power and a command receiving module configured to receive instructions sent by the central control module are integrally provided; and
the storage and retrieval robot further includes a control module connected to the command receiving module, the control module controls, according to a position coordinate received by the command receiving module, the movement of the walking mechanism.

Preferably, the storage mechanism includes a detection module configured to detect whether the tote is in place or not; and
the number of detection modules matches the number of storage places, and each detection module is integrally provided on each of the storage places for independently detecting the position of the tote within the storage place.

Preferably, a connection mode between the docking assembly and the docking mechanism is configured as at least one of the following: clamping docking, wedge docking, Torx coupling docking, or tension sleeve docking.

Preferably, the rotary transport mechanism includes a conveying device configured as at least one of the following: a chain device, a belt device, or a roller device.

In a second aspect, the present invention also provides a storage method applied to a high-density intelligent storage system as described above. The storage method includes: step S1 of loading goods into a tote; scanning the tote loaded with the goods to obtain data information of the tote, and using a central control module to match a rack assembly for storing the goods that corresponds to the tote and a position coordinate of the rack assembly, wherein the central control module sends the position coordinate to a command receiving module, the command receiving module analyses and plans a path to the position coordinate, and sends the planned path to a control module, a storage and retrieval robot carries the tote, the control module controls the storage and retrieval robot to transport the tote along the planned path to the rack assembly with the specified coordinate, the storage and retrieval robot is drivingly connected to the tote transport mechanism, and the tote transport mechanism transports the tote to a rack;
step S2 of determining whether the tote that has been loaded with the goods needs to be transferred; and
monitoring a value relationship between the number of totes in a rack assembly and a set value, and if the number of totes in the rack assembly is less than the set value, proceeding to step S2.1; or if the number of totes in the rack assembly is greater than or equal to the set value, proceed to step S2.2, wherein
the step S2.1 includes checking whether there is a further rack assembly of the same type, and if no, proceeding to step S4; or if yes, counting the number of totes for the further rack assembly of the same type and determining whether to transfer the tote based on whether an idle inventory ratio is greater than a set value: if the idle inventory ratio is greater than the set value, proceeding to step S4; or if the idle inventory ratio is less than the set value, transferring the tote of the rack assembly A to the further rack assembly of the same type and closing the rack assembly, wherein the idle inventory ratio=the total number of totes stored by the rack assemblies of this type/the maximum number of totes storable by the further rack assembly of the same type;
the step S2.2 includes checking whether there is a further rack assembly of the same type where the number of totes is less than a set value: if no, proceeding to step S4; or if yes, determining whether a new rack assembly of this type needs to be set up based on whether a total inventory ratio is greater than a set value: if no, transferring some of totes from the rack assembly to the further rack assembly of the same type whose number of totes is less than the set value until an inventory of the rack assembly is less than a set value; or if yes, proceeding to the step S4, wherein the total inventory ratio=the total number of totes stored by the rack assemblies of this type/the maximum number of totes storable by the rack assemblies of the same type;
step S3 of not transferring the tote, but proceeding to step S5;
step S4 of setting up a new rack assembly of this type and transferring some of the totes in the rack assembly to the new rack assembly; and step S5 of ending.

Preferably, in the step S1, it is determined whether to unload goods while loading goods, if it is determined to be yes, a tote having goods unloaded therefrom is identified, information of the tote having the goods to be unloaded therefrom is obtained, and the central control module is used to match a rack assembly that stores the tote and a position coordinate of the rack assembly. The central control module sends the position coordinate to the command receiving module, which analyses and plans a path to the position coordinate, and sends the planned path to the control module, the control module controls the storage and retrieval robot to move along the planned path to the rack assembly with the specified coordinate, the storage and retrieval robot is drivingly connected to the tote transport mechanism, and the tote transport mechanism transports the tote from the rack to the storage and retrieval robot; or if it is determined to be no, the method proceeds to the step S2.

### Beneficial Effects

According to a high-density intelligent storage system and a storage method of the present invention, the storage system includes rack assemblies and a storage and retrieval robot. A plurality of rack assemblies are provided and arranged in parallel. The storage and retrieval robot is configured to transfer a tote. An aisle is provided on at least one side of each rack assembly to facilitate the movement of the storage and retrieval robot. Each rack assembly includes a pair of racks arranged side-by-side, along with a tote transport mechanism that is in communication with the pair of racks to deliver totes between the two racks. The storage and retrieval robot is drivingly connected to the tote transport mechanism, and is configured to supply energy to the tote transport mechanism, and the storage and retrieval robot and the tote transport mechanism can deliver the tote to each other. With such an arrangement, the racks cooperate with the tote transport mechanism so that the layout design of the rack assemblies is rational and orderly, and the side-by-side placement of the racks can reduce the number of unnecessary aisles in a warehouse. Through the rational and orderly multi-tote parallel storage of the tote transport mechanism on the racks, the distance between adjacent totes is reduced, and the space utilisation rate of the warehouse is greatly increased.

The central control module is used for real-time monitoring of the operation state of the storage system, and the storage and retrieval robot cooperates with the central control module, to pick the totes on the racks in a rational and orderly manner, and rationally sort totes that are used frequently and totes that are not frequently used, so as to greatly improve the operation efficiency of the entire warehouse. In addition, the number of totes on the rack assembly is controlled, effectively avoiding the problem of too few totes on some rack assemblies and no rack assemblies for storing some types of totes.

### BRIEF DESCRIPTION OF FIGURES

FIG. 1 is a perspective view of the structure of a storage system according to an embodiment of the present invention from an axonometric perspective;

FIG. 2 is a top view of FIG. 1;

FIG. 3 is a left view of FIG. 1;

FIG. 4 is a cross-sectional view of FIG. 1 taken along an extension direction of an aisle;

FIG. 5 is a perspective view of the structure of a storage and retrieval robot docked with a rack assembly;

FIG. 6 is a perspective view of the structure of a tote transport mechanism according to an embodiment of the present invention;

FIG. 7 is a schematic exploded view of some components of FIG. 6;

FIG. 8 is a perspective view of the structure of a storage and retrieval robot according to an embodiment of the present invention;

FIG. 9 is a plan view of the structure of the storage and retrieval robot according to the embodiment of the present invention;

FIG. 10 is a perspective view of the structures of part of a docking structure and a docking assembly according to an embodiment of the present invention;

FIG. 11 is a first perspective view of the structure of the docking mechanism in FIG. 10; and

FIG. 12 is a second perspective view of the structure of the docking mechanism in FIG. 10.

### LIST OF REFERENCE SIGNS

1—rack assembly; 11—first rack; 12—second rack; 13—tote transport mechanism; 131—body; 1311—docking assembly; 13111—engagement pin; 13112—guide block; 1312—gear assembly; 1313—transport chain; 1314—load-bearing slide rail; 132—first tote; 133—second tote; 134—third tote; 2—storage and retrieval robot; 21—mobile chassis; 22—upright column; 23—lifting mechanism; 24—rotary transport mechanism; 25—docking head; 251—socket; 252—rotary slot; 253—limiting portion; 254—guide slot; 26—storage mechanism; 3—aisle.

### DETAILED DESCRIPTION OF EMBODIMENTS

In order to more clearly illustrate embodiments of the present invention or technical solutions in the prior art, specific embodiments of the present invention will be described below with reference to the accompanying drawings. Obviously, the accompanying drawings described below show merely some of the embodiments of the present invention, and those of ordinary skill in the art would also have obtained other accompanying drawings and other implementations according to these accompanying drawings without any creative effort.

The technical solutions of the present invention will be described in detail below by means of specific embodiments.

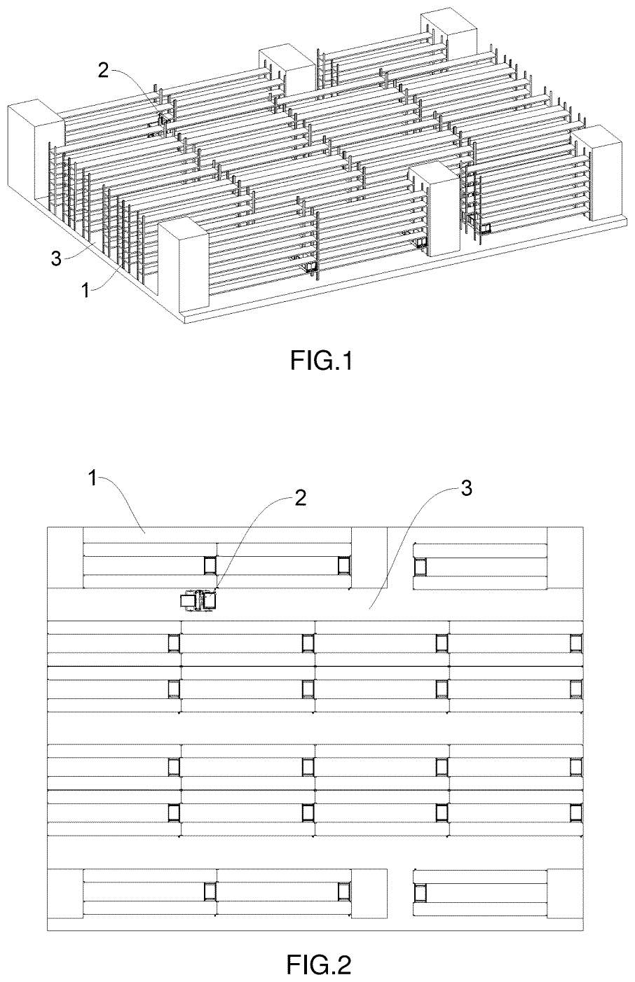

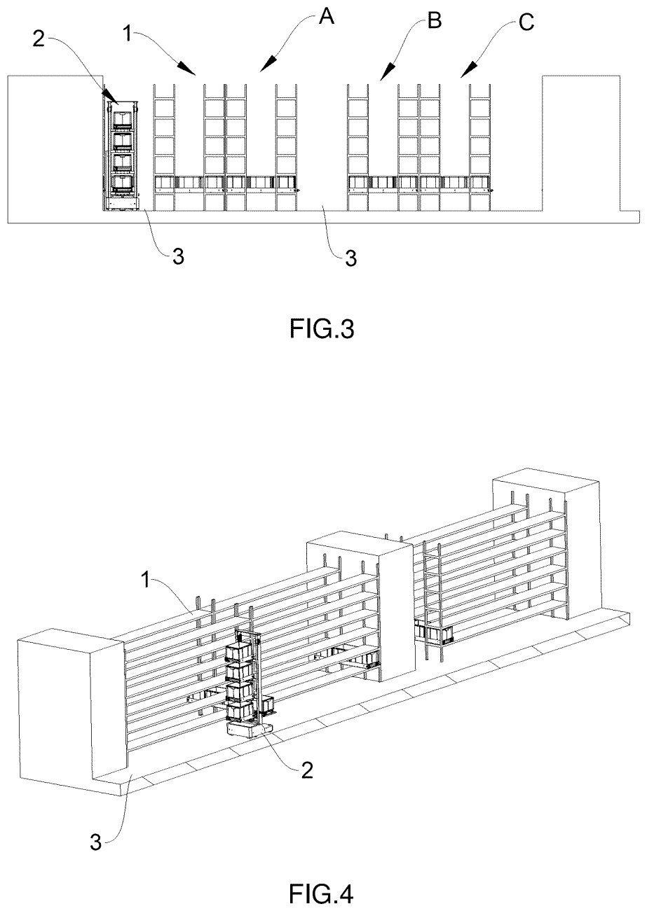

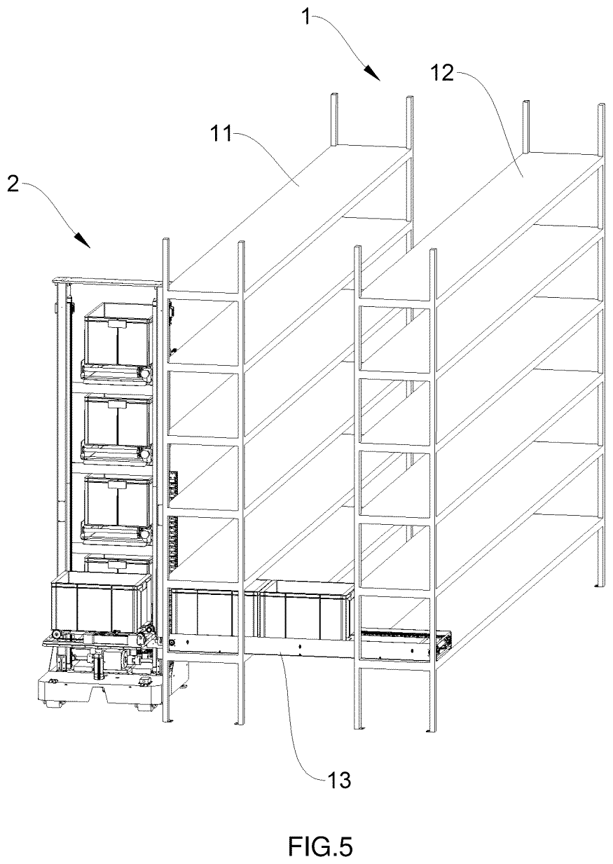

An embodiment of the present invention discloses a high-density intelligent storage system. Referring to FIGS. 1 to 4, the storage system includes rack assemblies 1 and a storage and retrieval robot 2. A plurality of rack assemblies 1 are provided, and the plurality of rack assemblies 1 are arranged in parallel. The storage and retrieval robot 2 is configured to transfer a tote. Referring to FIGS. 3, A, B, and C respectively denote three rack assemblies 1. An aisle 3 is provided on at least one side of each rack assembly 1. For example, an aisle 3 is provided on the right side of rack assembly A, and aisle 3 is provided on the left side of the rack assembly B. It can also be regarded that the two rack assemblies share one aisle 3. An aisle 3 is provided on the right side of rack assembly C, which is arranged adjacent to the rack assembly B. The aisles 3 allow for movement of the storage and retrieval robot 2. Referring further to FIG. 5, each rack assembly 1 includes a pair of racks arranged side-by-side and a number of tote transport mechanisms 13, each rack being provided with multiple layers. The two racks are respectively defined as a first rack 11 and a second rack 12. The tote transport mechanism 13 is in communication with the first rack 11 and the second rack 12 for delivering the tote between the two racks. The number of tote transport mechanisms 13 is set according to the number of totes. For ease of viewing, in the accompanying drawings of the present invention, there being only one tote transport mechanism 13 is taken as an example. Of course, there being a plurality of tote transport mechanism is also possible, and no additional detailed description will be made here. The storage and retrieval robot 2 is drivingly connected to the tote transport mechanism 13, and is configured to supply energy to the tote transport mechanism 13, and the storage and retrieval robot 2 and the tote transport mechanism 13 can deliver the tote to each other. With such an arrangement, the racks cooperate with the tote transport mechanism 13 so that the layout design of rack assemblies 1 is rational and orderly, and the side-by-side placement of the racks can reduce the number of unnecessary aisles 3 in a warehouse. Through the rational and orderly multi-tote parallel storage of the tote transport mechanism 13 on the racks, the distance between adjacent totes is reduced, and the space utilisation rate of the warehouse is greatly increased.

It can be understood that the racks mentioned in this embodiment are not limited to a particular structure, but may be storage apparatuses of any structure, such as flat racks, grid racks, and hollow racks.

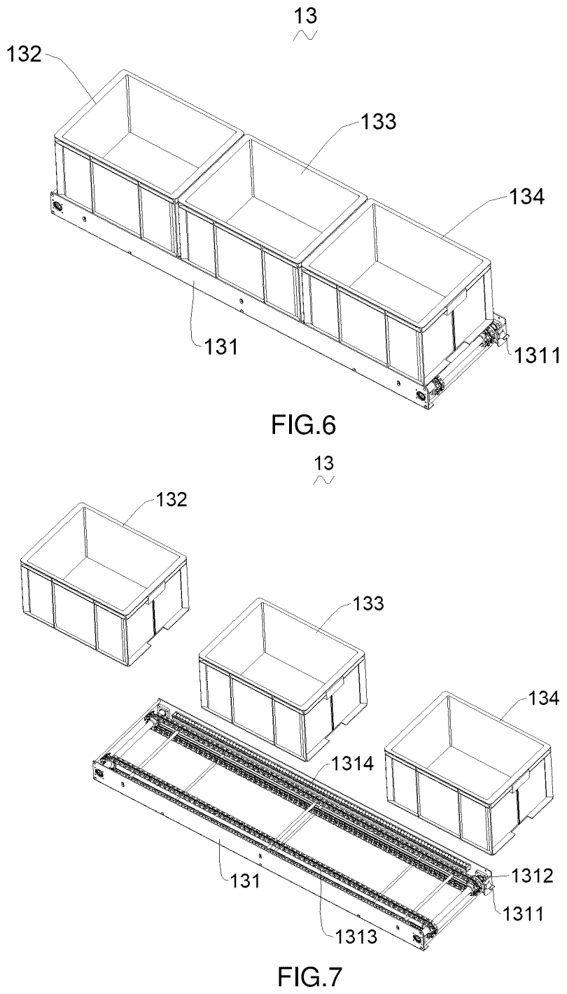

In particular, referring to FIGS. 6 and 7, the tote transport mechanism 13 includes a body 131 and a docking assembly 1311. The docking assembly 1311 is configured for connection with the storage and retrieval robot 2. The body 131 includes a gear assembly 1312 and a transport chain 1313. The gear assembly 1312 is drivingly connected to the docking assembly 1311 in a meshing manner. The gear assembly 1312 is further drivingly connected to the transport chain 1313, and the transport chain 1313 is configured to carry and convey the tote. Preferably, the body 131 further includes a load-bearing slide rail 1314. The load-bearing slide rail 1314 extends in a transport direction of the transport chain 1313, and the load-bearing slide rail 1314 and the transport chain 1313 both abut against the bottom surface of the tote. The load-bearing slide rail 1314 may be configured in such a way that a plurality of rollers are arranged in sequence, to convert a static friction force between the tote and the body 131 into a dynamic friction force to improve the conveying efficiency. Three totes are provided in FIGS. 6 and 7. For ease of distinction, the three totes are respectively defined as a first tote 132, a second tote 133 and a third tote 134. The first tote 132, the second tote 133 and the third tote 134 are arranged in sequence along the body 131 of the tote transport mechanism 13 and abut against each other. Depending on the rotation direction of the transport chain 1313, the movement direction of the totes is different. It can be understood that the transport chain 1313 may be replaced with another transport device. For example, the transport chain 1313 is replaced with a conveyor belt, the gear assembly 1312 is replaced with a roller assembly, the conveyor belt is sleeved on the roller assembly for carrying and transporting the tote, and the docking assembly 1311 is drivingly connected to the roller assembly. Such an implementation also falls within the scope of protection of the present invention.

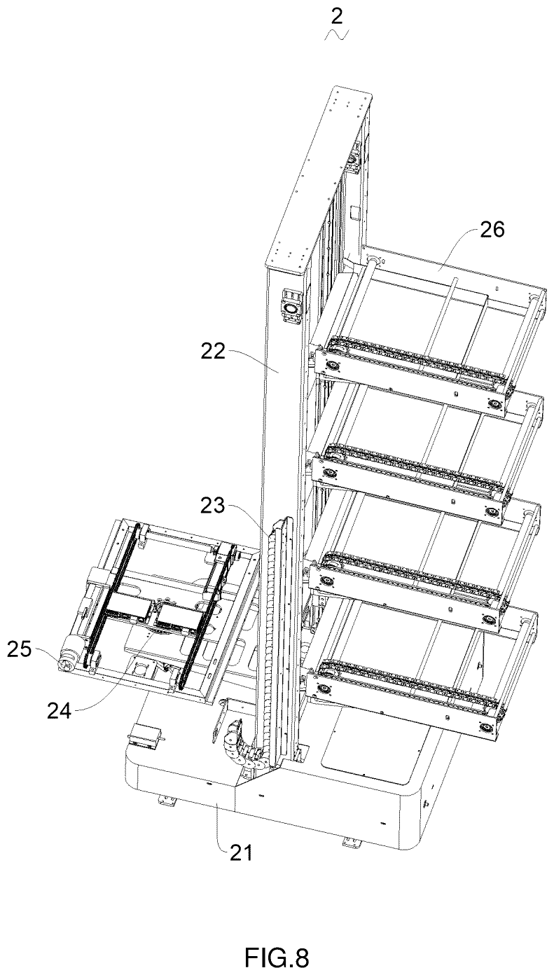

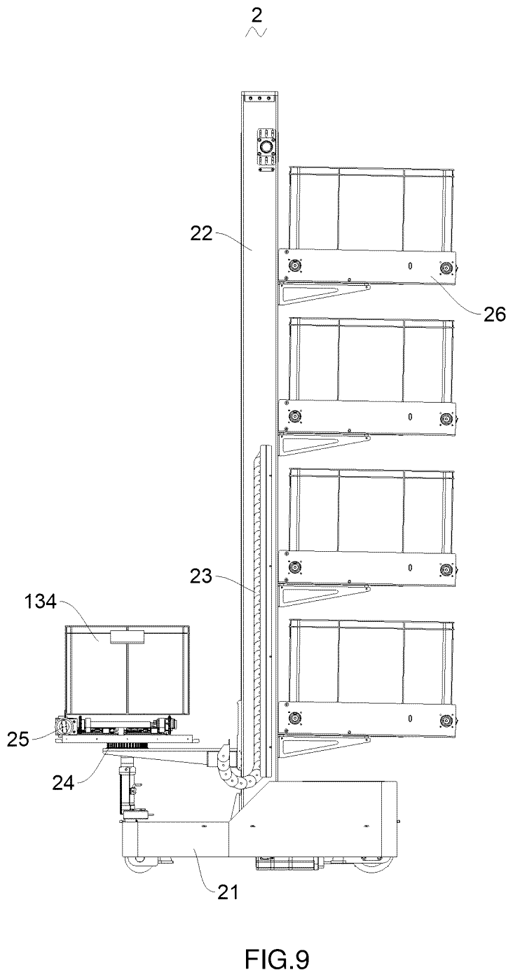

The storage system of this embodiment further includes a central control module configured to send instructions to the storage and retrieval robot 2. Referring to FIGS. 8 and 9, the storage and retrieval robot 2 includes a mobile chassis 21, and a walking mechanism configured to provide walking power and a command receiving module configured to receive instructions sent by the central control module are integrally provided within the mobile chassis 21. The storage and retrieval robot 2 further includes a control module connected to the command receiving module. The control module controls, according to a position coordinate received by the command receiving module, the movement of the walking mechanism to the position coordinate. An upright column 22 is fixedly provided on the mobile chassis 21, the upright column 22 is arranged in a vertical direction, and a storage mechanism 26 and a rotary transport mechanism 24 are respectively provided on two sides of the upright column 22. The storage mechanism 26 includes a plurality of storage places in a uniform array in an extension direction of the upright column 22, for storing totes. The rotary transport mechanism 24 is configured to transport a tote to the tote transport mechanism 13, or to receive a tote from the tote transport mechanism 13. Specifically, the storage and retrieval robot 2 further includes a docking mechanism, and the tote transport mechanism 13 includes a docking assembly 1311. The docking assembly 1311 and the docking mechanism are inserted into and drivingly connected, and the docking mechanism is integrated into the rotary transport mechanism 24. The upright column 22 is further provided with a lifting mechanism 23, and the rotary transport mechanism 24 is slidably connected to the lifting mechanism 23 so as to move in the vertical direction relative to the upright column 22. With such an arrangement, since the racks are provided with multiple layers, according to a different height of a tote on each layer of the rack, the rotary transport mechanism 24 can be moved to a corresponding specified height by the lifting mechanism 23, so that the docking assembly 1311 and the docking mechanism can be accurately docked with each other. When the docking assembly 1311 and the docking mechanism are inserted into each other, the rotary transport mechanism 24 is located upstream or downstream of the tote transport mechanism 13. When the storage and retrieval robot 2 retrieves a tote from the rack assembly 1, the docking mechanism drives the docking assembly 1311 to rotate, and the gear assembly 1312 of the tote transport mechanism 13 rotates, to drive the transport chain 1313 to rotate. As exemplified in FIG. 6, if a tote to be retrieved is the third tote 134, it is only necessary to move the third tote 134 along the tote transport mechanism 13 to the rotary transport mechanism 24 of the storage and retrieval robot 2. It can be understood that in order to facilitate the movement of the tote, the rotary transport mechanism 24 includes a conveying device similar to the combined structure of the transport chain 1313 and the gear assembly 1312 of the tote transport mechanism 13 described above. Specifically, the conveying device is configured as at least one of a chain device, a belt device and a roller device. If a tote to be retrieved is the second tote 133, it is necessary for the storage and retrieval robot 2 to first temporarily store the third tote 134, retrieve the second tote 133, and then deliver the third tote 134 back to the rack assembly 1. Specifically, after the third tote 134 is moved to the rotary transport mechanism 24, the rotary transport mechanism 24 is moved in the vertical direction relative to the upright column 22 by the lifting mechanism 23. When the nearest storage place is reached, the conveying device of the rotary transport mechanism 24 transfers the third tote 134 to this storage place. Preferably, each storage place is provided with an assembly similar to the load-bearing slide rail 1314 and the transport chain 1313 of the tote transport mechanism 13, and the rotary transport mechanism 24 can drive the chain to move to improve the efficiency of the movement of the tote in the storage place. The third tote 134 is temporarily stored in this storage place, and the rotary transport mechanism 24 is then moved along the upright column 22 and docked again with the tote transport mechanism 13 to retrieve the second tote 133. The aforementioned operation of moving the third tote 134 to the storage place is repeated, and the second tote 133 is moved to another storage place, and the rotary transport mechanism 24 is then moved to the storage place of the third tote 134, to deliver the third tote 134 back to the rack assembly 1 by means of the rotary transport mechanism 24. If a tote to be retrieved is the first tote 132, it is necessary to sequentially place the third tote 134 and the second tote 133 in the storage place, and then sequentially deliver the second tote 133 and the third tote 134 back to the rack assembly 1. The principle is the same as above and will not be repeated here.

Preferably, the storage mechanism 26 includes a detection module configured to detect whether the tote is in place or not. The number of detection modules is the same as the number of storage places, and one detection module is integrated into each of the storage places for independently detecting the position of the tote in the storage place. In the process of the storage and retrieval robot 2 retrieving the tote described above, if any one of the first tote 132, the second tote 133 and the third tote 134 needs to be temporarily stored in the storage place, the detection module operates independently, to determine whether the tote is in place, and the detection is also performed when the tote is out of place, to determine whether the tote is out of place.

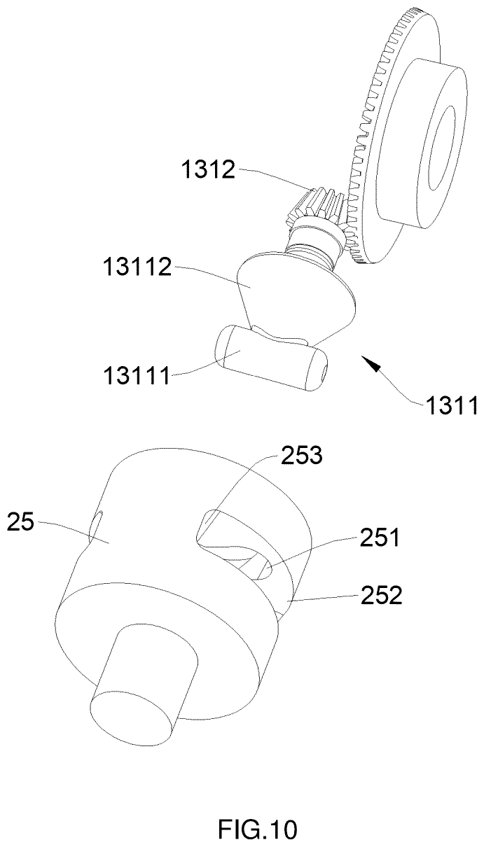

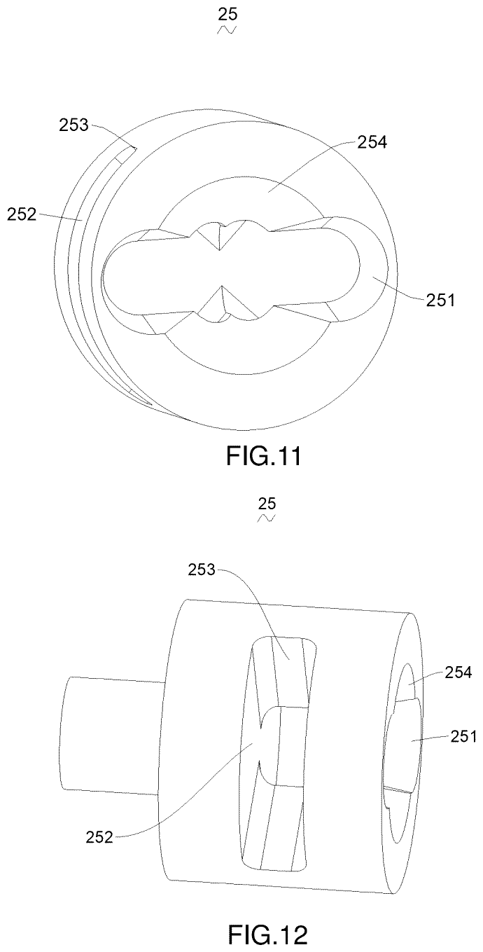

More specifically, referring to FIGS. 10 to 12, in which FIG. 10 is a perspective view of the structures of part of the docking structure and the docking assembly 1311. The docking structure includes an electric motor and a docking head 25. The electric motor is configured to drive rotation of the docking head 25, but is not shown in the figures. The docking assembly 1311 includes an integrally formed engagement pin 13111 and guide block 13112. The docking head 25 is provided with a socket 251 and a rotary slot 252 which are in communication with each other. The engagement pin 13111 passes through the socket 251 into the rotary slot 252, a side wall of the rotary slot 252 being provided with a limiting portion 253, and the docking head 25 is rotated such that the limiting portion 253 abuts against the engagement pin 13111, to drive the docking assembly 1311 to rotate. The socket 251 is provided with a guide slot 254, and the guide slot 254 and the guide block 13112 are matched in shape and size. Preferably, the guide slot 254 is configured to be tapered in shape, the guide slot 254 is in communication with the socket 251 and the rotary slot 252, and the size of the tapered guide slot 254 gradually increases from the rotary slot 252 to the socket 251. With such an arrangement, during insertion of the docking assembly 1311 into the docking head 25, the guide block 13112 gradually moves along the guide slot 254, until the engagement pin 13111 enters the rotary slot 252 and the guide block 13112 completely abuts against the guide slot 254. The guide slot 254 and the guide block 13112 can provide guide and positioning functions. Optionally, the docking head 25 and the docking assembly 1311 may also be interchanged. That is, the docking assembly 1311 is connected to the electric motor, and the docking head 25 is drivingly connected to the gear assembly 1312 in a meshing manner. The effect remains unchanged. It can be understood that, in addition to the insertion method between the docking structure and the docking assembly 1311 described in the above embodiments, it is possible to use at least one of clamping docking, wedge docking, Torx coupling docking and tension sleeve docking. Such a transformation also falls within the scope of protection of the present invention.

An embodiment of the present invention further provides a storage method applied to a high-density intelligent storage system as described above. The storage method includes: step S1 of loading goods into a tote; step S2 of determining whether the tote that has been loaded with the goods needs to be transferred; step S3 of not transferring the tote, but proceeding to step S5; step S4 of setting up a new rack assembly of this type and transferring some of the totes in the rack assembly to the new rack assembly; and step S5 of ending. The determination of whether the tote that has been loaded with the goods needs to be transferred in step S2 does not necessarily have to be carried out after the tote is loaded with goods, but may be carried out independently.

Specifically, during loading goods into a tote in step S1, the tote loaded with the goods is scanned, data information of the tote is obtained, and a central control module is used to match a rack assembly 1 for storing the goods that corresponds to the tote and a position coordinate of the rack assembly 1. The central control module sends the position coordinate to a command receiving module, the command receiving module analyses and plans a path to the position coordinate, and sends the planned path to a control module, a storage and retrieval robot 2 carries the tote, the control module controls the storage and retrieval robot 2 to transport the tote along the planned path to the rack assembly 1 with the specified coordinate, the storage and retrieval robot 2 is drivingly connected to a tote transport mechanism 13, and the tote transport mechanism 13 transports the tote to a rack.

Preferably, in step S1, it is determined whether to unload goods while loading goods, if it is determined to be yes, a tote having goods unloaded therefrom is identified, information of the tote having the goods to be unloaded therefrom is obtained, and the central control module is used to match a rack assembly that stores the tote and a position coordinate of the rack assembly. The central control module sends the position coordinate to the command receiving module, the command receiving module analyses and plans a path to the position coordinate, and sends the planned path to the control module, the control module controls the storage and retrieval robot 2 to move along the planned path to the rack assembly with the specified coordinate, the storage and retrieval robot 2 is drivingly connected to the tote transport mechanism 13, and the tote transport mechanism 13 transports the tote from the rack to the storage and retrieval robot 2; or if it is determined to be no, the method proceeds to step S2.

When performing step S2, there are two cases, S2.1 and S2.2. As exemplified in FIG. 3, a value relationship between the number of totes of rack assembly A and a set value is monitored. If the number of totes of the rack assembly A is less than the set value, the method proceeds to step S2.1; or if the number of totes of the rack assembly A is greater than or equal to the set value, the method proceeds to the step S2.2.

Step S2.1 includes checking whether there is a further rack assembly of the same type, and if no, proceeding to step S3; or if yes, counting the number of totes for the further rack assembly of the same type and determining whether to transfer the tote based on whether an idle inventory ratio is greater than a set value: if the idle inventory ratio is greater than the set value, proceeding to the step S3; or if the idle inventory ratio is less than the set value, transferring the tote of the rack assembly A to the further rack assembly of the same type and closing the rack assembly. The idle inventory ratio=(equals) the total number of totes stored by the rack assemblies of this type/(divided by)the maximum number of totes stored by the further rack assembly of the same type.

The idle inventory ratio=(equals) the total number of totes stored by the rack assemblies of this type/(divided by)the maximum number of totes stored by the further rack assembly of the same type.

Step S2.2 includes checking whether there is a further rack assembly of the same type where the number of totes is less than a set value: if no, proceed to step S4; or if yes, determine whether a new rack assembly of this type needs to be set up depending on whether a total inventory ratio is greater than a set value: if no, transferring some of the totes in the rack assembly A to the further rack assembly of the same type where the number of totes is less than the set value until an inventory of the rack assembly A is less than a set value; or if yes, proceeding to the step S4.

The total inventory ratio=(equals) the total number of totes stored by the rack assemblies of this type/(divided by)the maximum number of totes stored by the rack assemblies of the same type.

With such an arrangement, the central control module is used for real-time monitoring of the operation state of the storage system, and the storage and retrieval robot cooperates with the central control module, to pick the totes on the racks in a rational and orderly manner, and rationally sort totes that are used frequently and totes that are not frequently used, so as to greatly improve the operation efficiency of the entire warehouse. In addition, the number of totes on the rack assembly is controlled, effectively avoiding the problem of too few totes on some rack assemblies and no rack assemblies for storing some types of totes.

In summary, according to a high-density intelligent storage system and a storage method of the present invention, the storage system includes rack assemblies 1 and a storage and retrieval robot 2. A plurality of rack assemblies 1 are provided, and the plurality of rack assemblies 1 are arranged in parallel. The storage and retrieval robot 2 is configured to transfer a tote. An aisle 3 is provided on at least one side of each rack assembly 1 for allowing for movement of the storage and retrieval robot 2. Each rack assembly 1 includes a pair of racks arranged side-by-side and a tote transport mechanism 13. The tote transport mechanism 13 is in communication with the pair of racks for delivering a tote between the two racks. The storage and retrieval robot 2 is drivingly connected to the tote transport mechanism 13, and is configured to supply energy to the tote transport mechanism 13, and the storage and retrieval robot 2 and the tote transport mechanism 13 can deliver the tote to each other. With such an arrangement, the racks cooperate with the tote transport mechanism 13 so that the layout design of rack assemblies 1 is rational and orderly, and the side-by-side placement of the racks can reduce the number of unnecessary aisles 3 in a warehouse. Through the rational and orderly multi-tote parallel storage of the tote transport mechanism 13 on the racks, the distance between adjacent totes is reduced, and the space utilisation rate of the warehouse is greatly increased.

The embodiments of a high-density intelligent storage system and a storage method provided by the present invention are described in detail above. Although the principle and implementations of the present invention are described herein by using specific examples, the above description of the embodiments is merely intended to help understand the core concept of the present invention. It should be noted that several improvements and modifications may also be made to the present invention by those of ordinary skill in the art without departing from the principles of the present invention, and should also fall within the scope of protection of the present invention.

What is claimed is:

1. A high-density intelligent storage system, comprising:
rack assemblies (1), a plurality of rack assemblies (1) being provided, and the plurality of rack assemblies (1) being arranged in parallel; and
a storage and retrieval robot (2) configured to transfer a tote, wherein
an aisle (3) is provided on at least one side of each rack assembly (1) for allowing for movement of the storage and retrieval robot (2);
each rack assembly (1) comprises a pair of racks arranged side-by-side and a number of tote transport mechanisms (13), each tote transport mechanism (13) being in communication with the pair of racks arranged side-by-side for delivering a tote between the two racks; and
the storage and retrieval robot (2) is drivingly connected to the tote transport mechanism (13), and the storage and retrieval robot (2) and the tote transport mechanism (13) are capable of delivering the tote to each other.

2. The high-density intelligent storage system according to claim 1, wherein the storage and retrieval robot (2) comprises a docking mechanism, the tote transport mechanism (13) comprises a docking assembly (1311), and the docking assembly (1311) and the docking mechanism are drivingly connected.

3. The high-density intelligent storage system according to claim 2, wherein the tote transport mechanism (13) comprises a body (131), the body (131) comprising a gear assembly (1312) and a transport chain (1313), wherein the gear assembly (1312) is drivingly connected to the docking assembly (1311) in a meshing manner; and
the gear assembly (1312) is further drivingly connected to the transport chain (1313), and
the transport chain (1313) is configured to carry and convey the tote.

4. The high-density intelligent storage system according to claim 2, wherein the tote transport mechanism (13) comprises a body (131), the body (131) comprising a roller assembly and a conveyor belt, wherein the conveyor belt is sleeved on the roller assembly for carrying and conveying the tote, and the docking assembly (1311) is drivingly connected to the roller assembly.

5. The high-density intelligent storage system according to claim 2, wherein the storage and retrieval robot (2) further comprises a rotary transport mechanism (24) and an upright column (22), wherein the rotary transport mechanism (24) is located upstream or downstream of the tote transport mechanism (13) when the docking assembly (1311) and the docking mechanism are inserted into each other, and the docking mechanism is integrated into the rotary transport mechanism (24);
the upright column (22) is arranged in a vertical direction; and
the upright column (22) is provided with a lifting mechanism (23), and the rotary transport mechanism (24) is slidably connected to the lifting mechanism (23) so as to move in the vertical direction relative to the upright column (22).

6. The high-density intelligent storage system according to claim 5, wherein the storage and retrieval robot (2) further comprises a storage mechanism (26), and the storage mechanism (26) and the rotary transport mechanism (24) are respectively arranged on two sides of the upright column (22); and
the storage mechanism (26) comprises a plurality of storage places in a uniform array in an extension direction of the upright column (22).

7. The high-density intelligent storage system according to claim 3, wherein the body (131) further comprises a load-bearing slide rail (1314), the load-bearing slide rail (1314) extending in a transport direction of the transport chain (1313), and the load-bearing slide rail (1314) and the transport chain (1313) both abutting against a bottom surface of the tote.

8. The high-density intelligent storage system according to claim 1, further comprises a central control module, wherein the central control module is configured to send an instruction to the storage and retrieval robot (2);
the storage and retrieval robot (2) comprises a mobile chassis (21), and a walking mechanism configured to provide walking power and a command receiving module configured to receive the instruction sent by the central control module are integrally provided within the mobile chassis (21); and
the storage and retrieval robot (2) further comprises a control module connected to the command receiving module, the control module controlling, according to a position coordinate received by the command receiving module, the movement of the walking mechanism to the position coordinate.

9. The high-density intelligent storage system according to claim 6, wherein the storage mechanism (26) comprises a detection module configured to detect whether the tote is in place or not; and
the number of detection modules is the same as the number of storage places, and one detection module is integrally provided on each of the storage places for independently detecting the position of the tote in the storage place.

10. The high-density intelligent storage system according to claim 2, wherein a connection mode between the docking assembly (1311) and the docking mechanism is configured as at least one of clamping docking, wedge docking, Torx coupling docking and tension sleeve docking.

11. The high-density intelligent storage system according to claim 5, wherein the rotary transport mechanism (24) comprises a conveying device configured as at least one of a chain device, a belt device and a roller device.

12. A storage method applied to a high-density intelligent storage system of any one of claims 1-11, the storage method comprising:
step S1 of loading goods into a tote; and scanning the tote loaded with the goods, obtaining data information of the tote, and using a central control module to match a rack assembly for storing the goods that corresponds to the tote and a position coordinate of the rack assembly, wherein the central control module sends the position coordinate to a command receiving module, the command receiving module analyses and plans a path to the position coordinate, and sends the planned path to a control module, a storage and retrieval robot carries the tote, the control module controls the storage and retrieval robot to transport the tote along the planned path to the rack assembly with the specified coordinate, the storage and retrieval robot is drivingly connected to the tote transport mechanism, and the tote transport mechanism transports the tote to a rack;
step S2 of determining whether the tote that has been loaded with the goods needs to be transferred; and
monitoring a value relationship between the number of totes of a rack assembly and a set value, and if the number of totes of the rack assembly is less than the set value, proceeding to step S2.1; or if the number of totes of the rack assembly is greater than or equal to the set value, proceeding to step S2.2, wherein
the step S2.1 comprises checking whether there is a further rack assembly of the same type, and if no, proceeding to step S3; or if yes, counting the number of totes for the further rack assembly of the same type and determining whether to transfer the tote based on whether an idle inventory ratio is greater than a set value: if the idle inventory ratio is greater than the set value, proceeding to the step S3; or if the idle inventory ratio is less than the set value, transferring the tote of the rack assembly to the further rack assembly of the same type and closing the rack assembly, wherein the idle inventory ratio=the total number of totes stored by the rack assemblies of this type/the maximum number of totes storable by the further rack assembly of the same type;
the step S2.2 comprises checking whether there is a further rack assembly of the same type where the number of totes is less than a set value: if no, proceeding to step S4; or if yes, determining whether a new rack assembly of this type needs to be set up depending on whether a total inventory ratio is greater than a set value: if no, transferring some of the totes in the rack assembly to the further rack assembly of the same type where the number of totes is less than the set value until an inventory of the rack assembly is less than a set value; or if yes, proceeding to the step S4, wherein the total inventory ratio=the total number of totes stored by the rack assemblies of this type/the maximum number of totes storable by the rack assemblies of the same type;
step S3 of not transferring the tote, but proceeding to step S5;
step S4 of setting up a new rack assembly of this type and transferring some of the totes in the rack assembly to the new rack assembly; and
step S5 of ending.
